(19) United States
(12) Patent Application Publication
(10) Pub. No.: US 2011/0254270 A1
(43) Pub. Date: Oct. 20, 2011

(54) Wave gear drive -WGD

(76) Inventor: Shamil Sami Ayntrazi, Vienna, VA (US)

(21) Appl. No.: 12/798,902

(22) Filed: Apr. 14, 2010

(51) Int. Cl. F03B 13/18; H02P 9/48

(52) U.S. Cl. 290/42; 290/53

(57) ABSTRACT

The Wave Gear Drive, WGD system is a new method for directly converting sea wave energy to mechanical drive using wave undulations and a buoyant float directly acting on a spiral spring or rack and pinion or power pulley system to drive a rotary or reciprocating water pump that pumps a small quantity of water to a high head, collect it and feed it directly or in conjunction with a water reservoir on top of the offshore WGD system supporting structure, to a hydro turbo generator to generate leveled electric power covering the full wave cycle duration and transmit it to the shore using power and control cables laid at the sea bed, or to drive a polyphase generator to generate electric current, control and condition it to operate in parallel, and transmit it to shore using power and control cables laid at the sea bed; in addition to ebb/tide turbo generators and wind turbo generators that are part of the offshore REWGD system which provides access platform for the wind turbines for ease of construction and maintenance; and provides a break water system.

### CROSS-REFERENCE TO RELATED APPLICATIONS

### Listed by USPTO

U.S. Pat. No. 6,388,342 05-2002 Vattrick et al 290/53

US-005842838A 12-1998 Berg 417/331

U.S. Pat. No. 4,398,095 08-1983 Ono 290/53

U.S. Pat. No. 7,199,481 B2 04-2007 Hirsch, William Walter 290/42

U.S. Pat. No. 7,164,212 B2 01-2007 Leijon et al. 290/42

U.S. Pat. No. 6,956,299 B2 10-2005 Serrano Molina et al. 290/42

U.S. Pat. No. 6,768,217 B2 07-2004 Chalmers et al. 290/53

U.S. Pat. No. 6,768,216 B1 07-2004 Carrol et al. 290/42

U.S. Pat. No. 6,392,314 B1 05-2002 Dick, William 290/53

U.S. Pat. No. 4,883,411 11-1989 Windle, Tom J. 417/331

U.S. Pat. No. 4,754,157 06-1988 Windle, Tom J. 290/53

U.S. Pat. No. 4,326,840 04-1982 Hicks et al. 417/331

U.S. Pat. No. 3,930,168 12-1975 Tomabene, Michael g. 290/53

U.S. Pat. No. 3,918,260 11-1975 Mahneke, Klaus M. 60/500

The above do not resemble the WGD system as proposed under this application. Although many devices had been invented, none compares with this invention as to simplicity, efficiency and to economy. References are principles of hydraulic and electrical engineering. In addition, the WGD system can be a standalone installation or an addition to existing power plants.

The WGD converts sea wave energy directly into electric power using polyphase generator sets or be means of pumping water into a hydro turbo generator, is scalable, requires a minimum water depth of eighteen (18) meters, and can be installed far away offshore.

### STATEMENT REGARDING FEDERALLY SPONSORED RESEARCH OR DEVELOPMENT

Not Applicable

### NAMES OF THE PARTIES TO A JOINT RESEARCH AGREEMENT

Not Applicable

### REFERENCE TO SEQUENCE LISTING, A TABLE, OR A COMPUTER

Not Applicable

### PROGRAM LISTING

Not Applicable

### INCORPORATION BY REFERENCE OF MATERIALS SUBMITTED ON COMPACT DISC

Not Applicable

### COMPACT DISK

Not Applicable

### APPENDIX

Not Applicable

### BACKGROUND OF THE INVENTION

The invention pertains to USPTO Class 290/42 Tide and wave Motors and to Class 310 generators.

The idea of converting sea wave energy into electric energy had been investigated by many who proposed different devices. However; these devices are limited in the amount of power they produce, have low efficiency, require expensive structures, and are unable to produce power in sizeable quantities.

The available renewable energy in the seas and oceans, the cost of new power plants, the rising costs of fuel and the need for environment control: CO2 and emissions of pollutants to the atmosphere and shoreline protection, all dictate investigating and developing new sources of renewable energy.

The oceans cover a little more than 70 percent of the Earth's surface. This makes them the world's largest solar energy collector and energy storage system. According to the World Energy Council, the global energy available from undulation energy conversion is two trillion Watt Hours/year. Tapping just 0.2 percent of this energy would satisfy current global demand for electricity.

During the next 20 years, experts foresee a need for 1,500 GW of additional electric power supply to meet new power demand. This equals to 15,000 new power plants, each 100 MW, and represents building for the next twenty years 100 MW power plants at the rate of 750 per year.

The fuel consumption for these power plants is estimated at 59 million barrels of oil per day. CO2 release to the atmosphere is estimated at 2.2 billion tons per year. The world Bank estimates that developing countries alone will need to spend 100 billion US$ each year for the next 30 years, installing new power plants, most of which will be in the equatorial Zone.

Hence, switching to alternate energy is urgently needed. Among the alternate energy resources, wave energy is considered as one of the most promising alternate energy source due to high concentration factor and to high availability factor day & night compared to wind and Solar energy.

“New” The invention provides maximum utilization of offshore sea area, levels wave energy power output by the use of a water reservoir on top of the offshore structure to provide power for a duration exceeding the duration of the wave cycle, provides dependable power output even in the absence of waves by adding ebb/tide turbo generators and wind turbines, and reduces the structural steel required for the offshore wind turbines support and provides access platforms for offshore wind turbines for ease of installation and maintenance.

Civilizations can be tied to, indeed equated to energy utilization. America consumes nearly a quarter of the world power supply. That is 4% of the population consume 25% of world power.

### BRIEF SUMMARY OF THE INVENTION

Since real estate at the shoreline is scarce and expensive, protection against severe storms is a must, offshore waves have higher amplitudes, maximum utilization of sea area and available renewable energy is required.

An offshore fixed structure is proposed to house all equipment and extract: wave energy, ebb/tide energy and wind energy and pumped water storage are provided in the form of pumped water to a high reservoir, all combined into one system to provide competitive and dependable energy output, even in the absence of one or more renewable energy source.

The pumped water storage reservoir provides energy storage of 1,521,000 kilogram meters, which is used to level REWGD system power output during the full wave cycle, irrespective of its duration.

Sheeting the shore side of the fixed structure would attenuate the wave height, hence increasing wave energy extraction and making the fixed structure act as a break water structure.

The invention is a method for extracting sea wave energy using wave undulations and a buoyant float to directly act on spiral spring or a rack and pinion or a set of pulleys to drive:
a. A water pump that pumps a small quantity of water to a high head, collect it and feed it to an onshore or offshore hydro turbo generator to generate electric power and transmit it to the shore using power and control cables laid at the sea bed, or
b. Directly drive a generator to generate electric power, alternating or direct current, operate in parallel and transmit the current to the shore using power and control cables laid at the sea bed.

### BRIEF DESCRIPTION OF THE SEVERAL VIEWS OF THE DRAWING

FIG. 1 WGD System Layout Fixed Structure and Cover Sheet. It includes patent cover sheet and a schematic diagram for the whole system with identification of parts.

FIG. 2 WGD System Layout Floating Structure. It includes equipment and its identification of parts.

FIG. 3 WGD System Details. It includes the mooring system and identification of parts.

“Amended” FIG. 4 WGD System Mooring. It includes water flow layout, piping and identification of parts.

FIG. 5 WGD System Water Flow. It includes layout of power and control cables and identification of parts.

FIG. 6 WGD Power & Control Cables. It includes a block layout of system with power and control cables.

FIG. 7 WGD System Layout and Power output, It includes layout of power and control cables and identification of parts.

FIG. 8 WGD System Prototype Plan @ +550 cm Level. It includes layout of different Pumps, Generators and identification of parts.

FIG. 9 WGD System Prototype Plan @ −550 cm Level. It includes layout of different Pumps, Generators and identification of parts.

FIG. 10 WGD System Prototype Elevation. It includes layout of different Pumps, Generators and identification of parts.

FIG. 11 WGD System Prototype Details. It includes layout of Wind Turbine and of different Pumps, Generators and identification of parts.

FIG. 12 WGD System Prototype Details and Wind Turbine Pumps. It includes layout of Wind Turbine and of different Pumps, Generators and identification of parts.

FIG. 13 WGD System Prototype Block Diagram. It includes layout of Wind Turbine and of different Pumps, Generators and identification of parts.

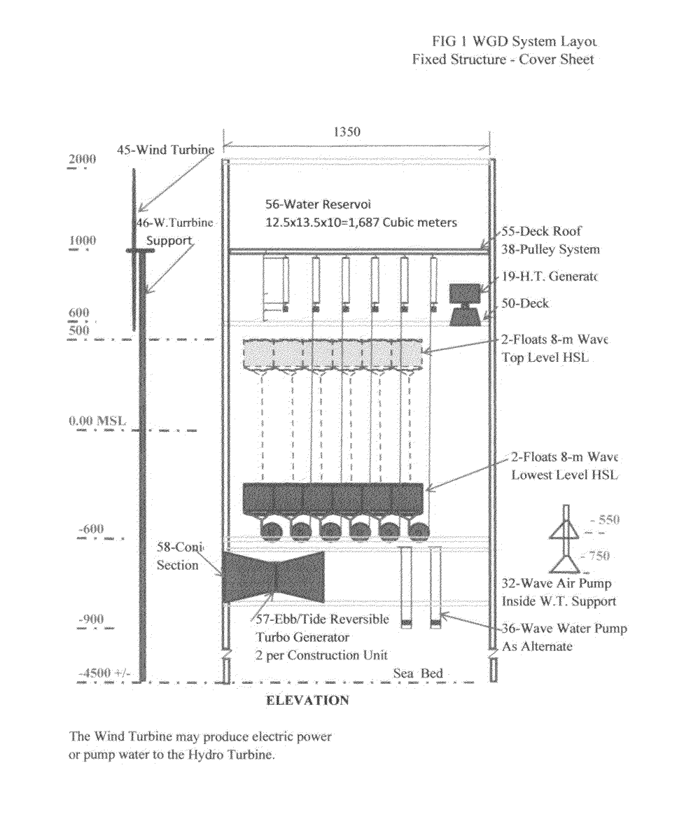

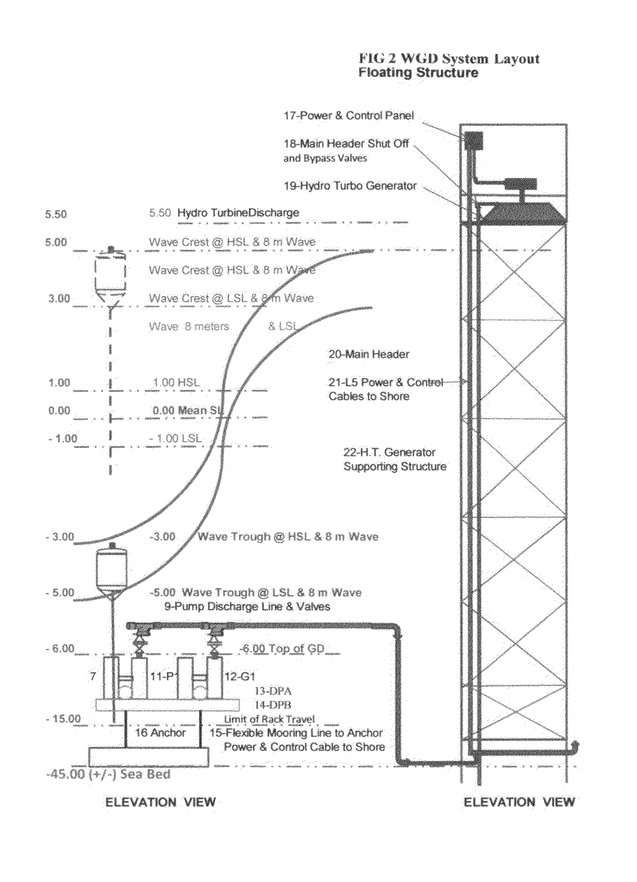

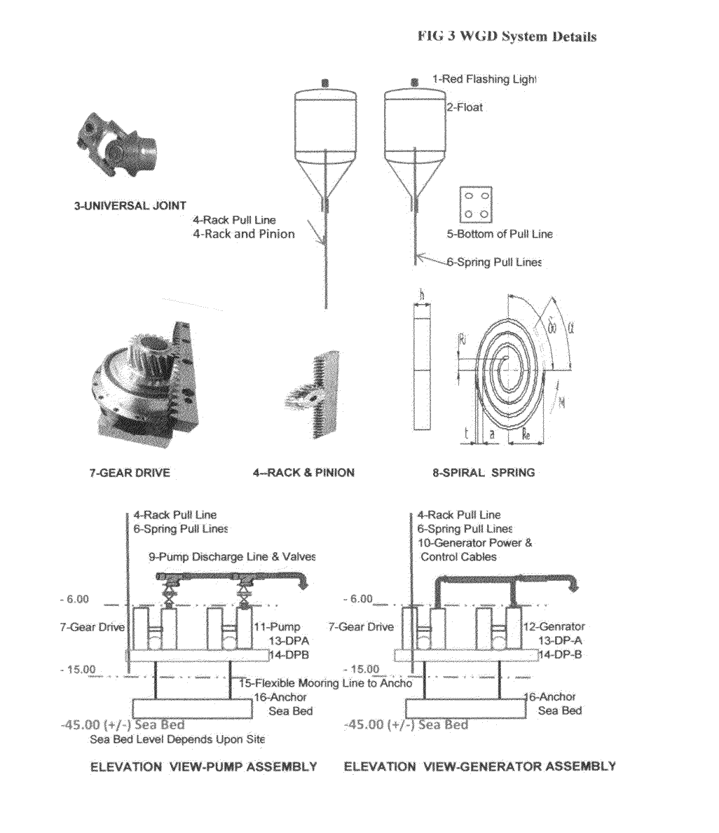

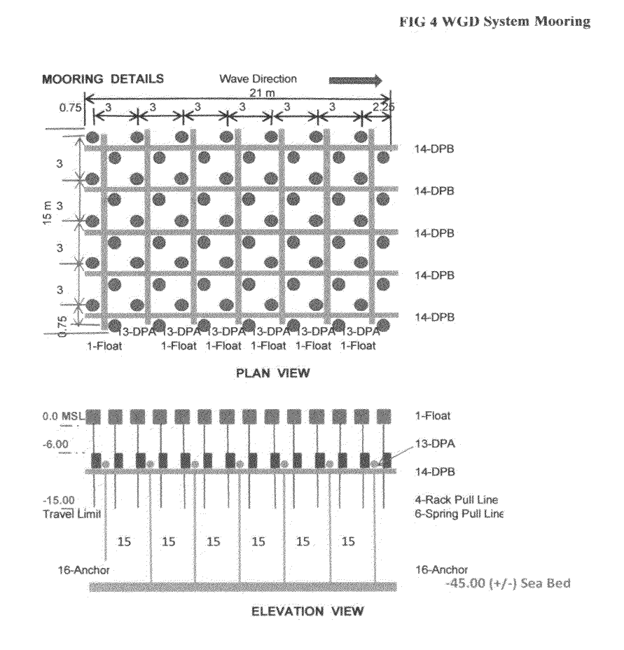

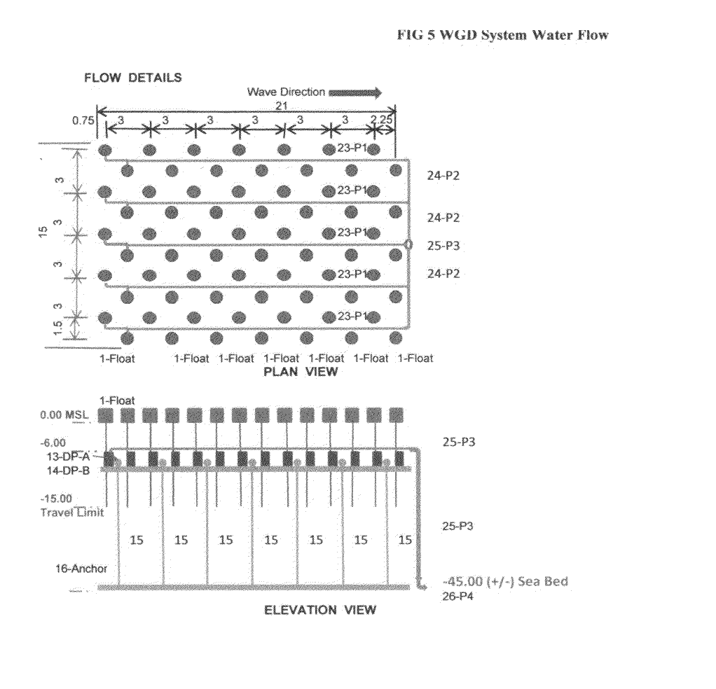

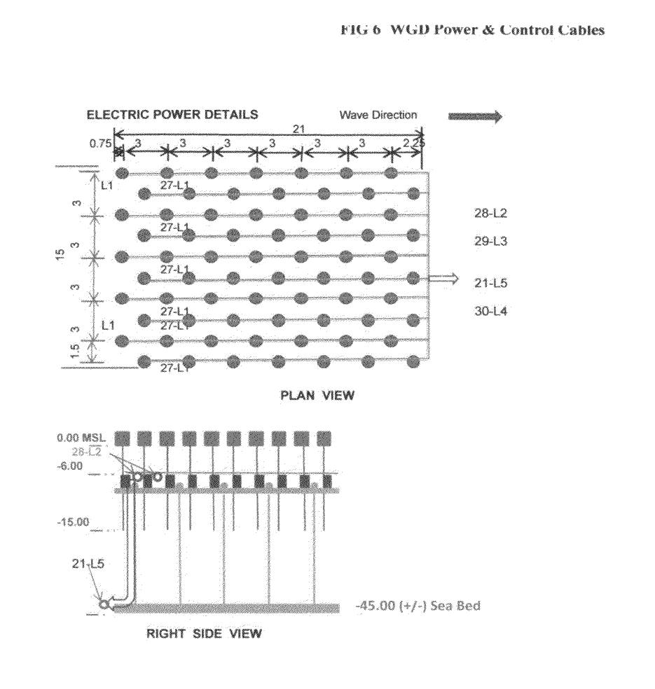

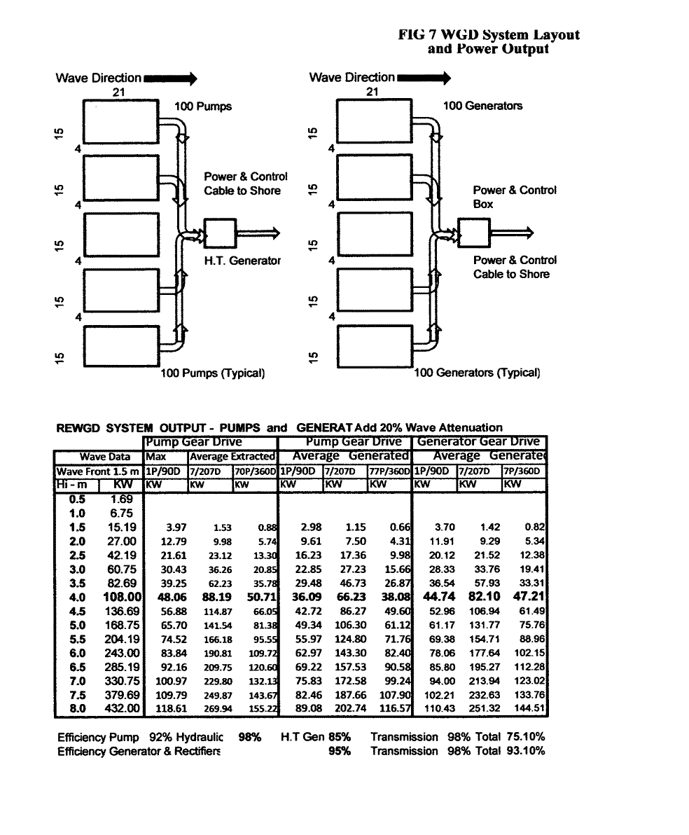

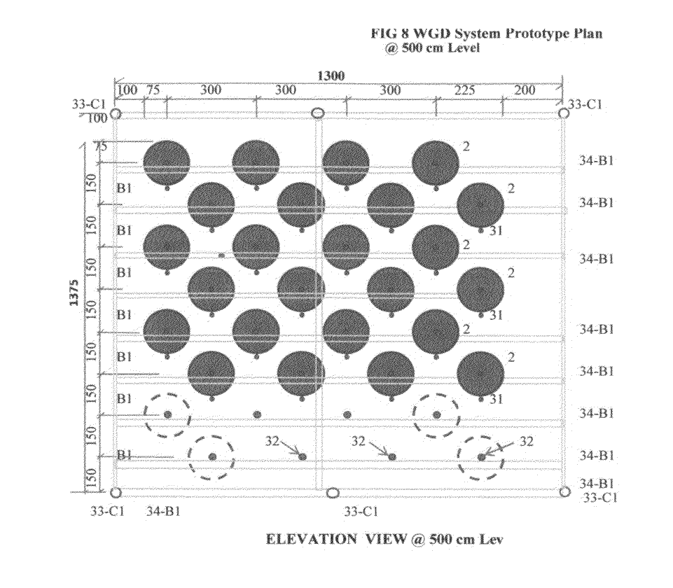

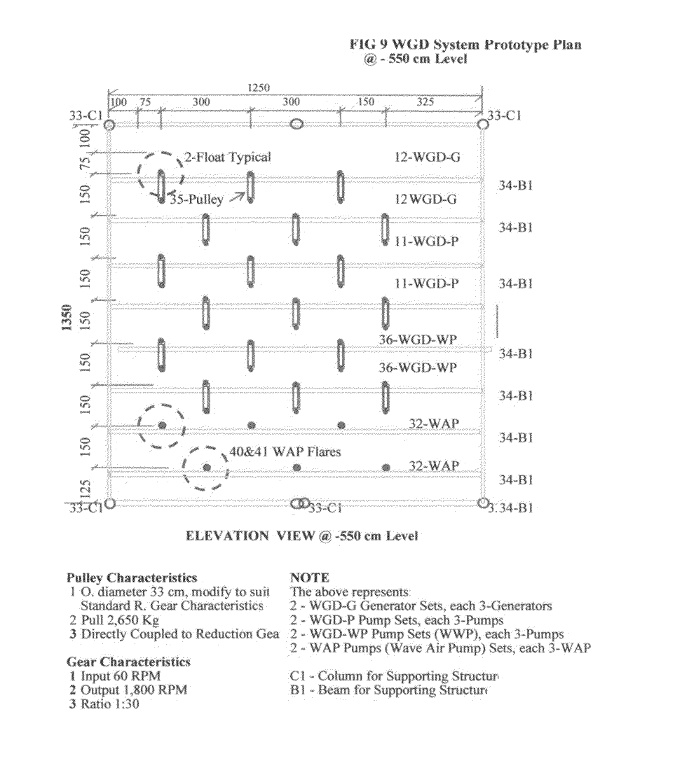

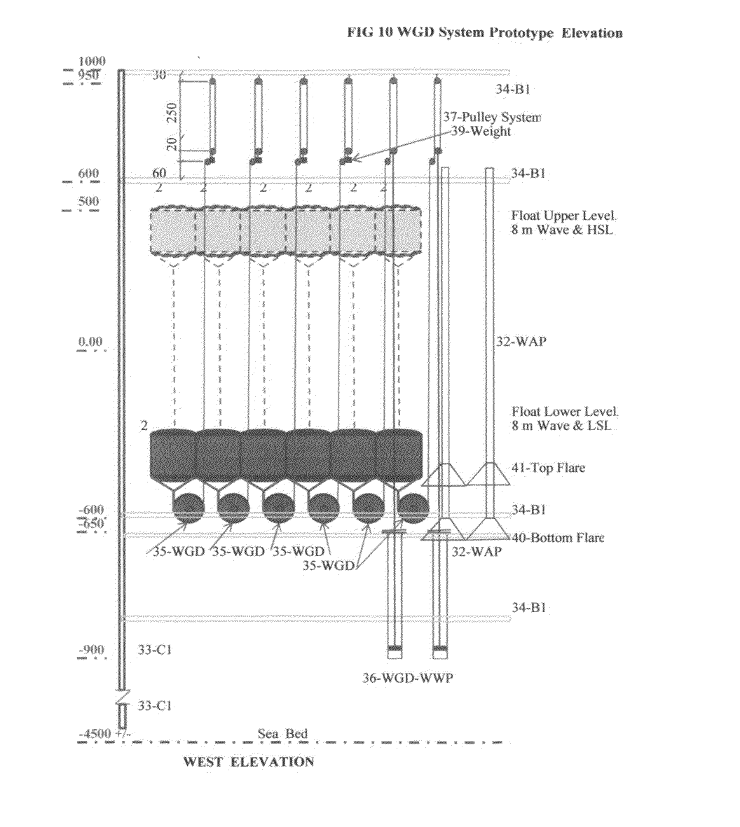

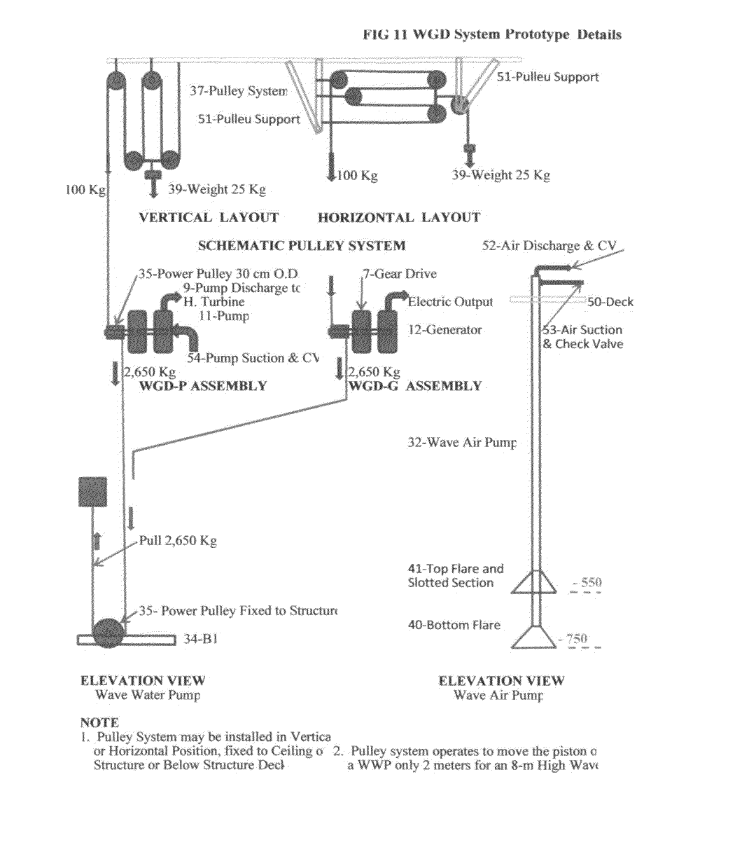

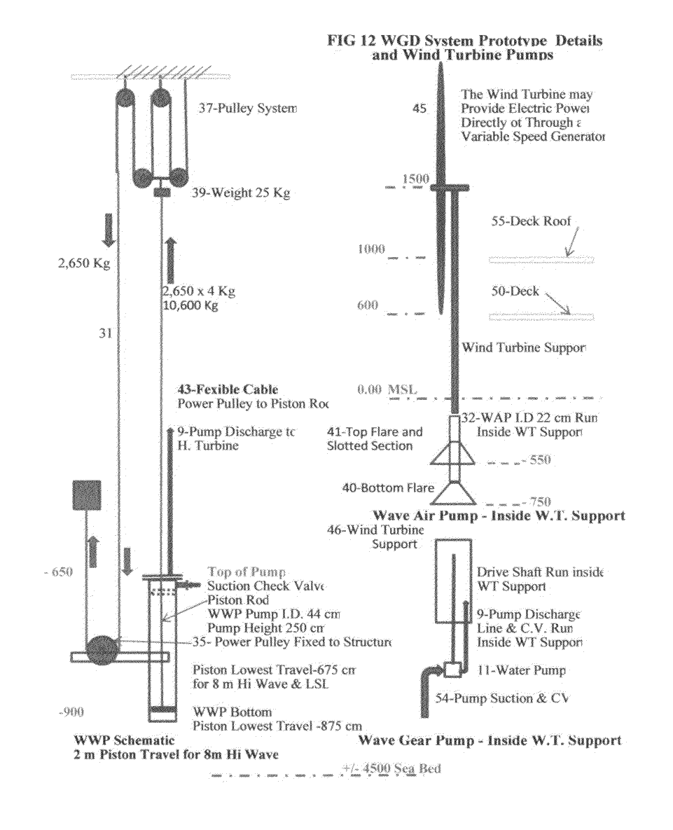

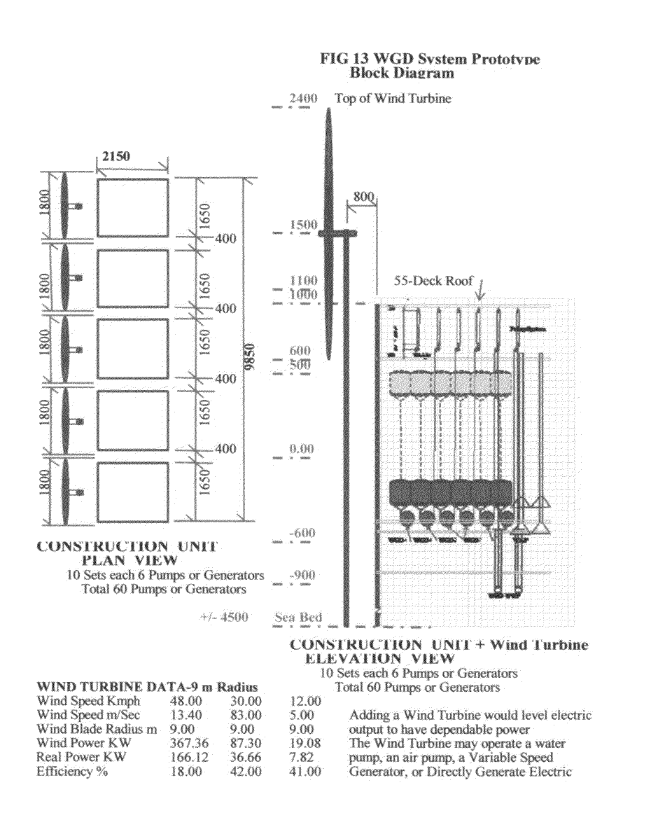

Identification of parts: 1—Red Flashing Light, 2—Float, 3—Universal Joint, 4—Rack Pull Lines, 5—Bottom of Pull Lines, 6—Spring Pull Line, 7—Gear Drive, 8—Spiral Spring, 9—Pump Discharge Line and Valves, 10—Generator Power and Control Cable, 11—P1 to P10 Pumps are rotary or centrifugal, 12—Generator, 13—DPA, Dummy Pipe-A, 14—DPB, Dummy Pipe-B, 15—Flexible Moring Line to Anchor, 16—Anchor, ‘17—Power and Control Panel, 18—Main Header Shut Off and Bypass Valves, 19—Hydro Turbo Generator, 20—Main Header, 21—L5 Power and Control Cables to Shore 22—H.T. Generator Supporting Structure, 23—P1, Is a discharge pipe that collects the pumps discharge for each set of 10 pumps 25—P3 Common Pump Discharge Line Collects 24—P2 Is a common discharge pipe that collects the discharge of pipes 23—P1, 26—P4 Common Pump Discharge Line Collects 25—P3 and Discharges into the hydro turbo generator, 27—L1 are power and Control Cables interconnect each set of 10 Generators, 28—L2 Power and Control Cables interconnect each set of 100 Generators, 29—L3 Power and Control Cables that interconnect of 50 Generators, 30—L4 Power and Control Cables interconnect each set of 10 Generators, 31—Flexible Float Pull Line, 32—Wave Air. Pump, 33—C1 Structure Column, 34—B1 Structure Beam, 35—Power Pulley, 36—Wave Water Pump, 37—Pulley System, Vertical for WWP, 38—Pulley System, Vertical for WGD-G and WGD-P, 40—Bottom Flare for WAP, 41—Top Flare for WAP, 42—Pulley System, Horizontal, 43—Flexible Line, Piston Rod to Pulley System, 44—Piston Rod for WWP, 45—Wind Turbine, 46—Wind Turbine Support, 47—Discharge Line and Check Valves for WWP, 48—Suction Check Valve in WWP-Dec, 49—Drive Shaft from Wind Turbine, Run Inside Structure, 50—Deck, 51—Pulley Support, 52—Air Discharge and Check Valve, 53—Air Suction Check Valve, 54—Pump Auction and Check Valve, 55—Deck Roof, 56—Water Reservoir, 57—Ebb/Tide Reversible Turbo Generator, 58—Conic Section.

### Listing of Tables

TABLE 1
WGD Performance, for Wave Heights1.5 to 8 meters,
for 1-Pump or Generator, and for sets of 10 Pumps or Generators.

| | | Pump Gear Drive | | | Pump Gear Dnve | | | Generator Gear Drive | | |
|---|---|---|---|---|---|---|---|---|---|---|
| Wave Data | | Max | Average Extracted | | Average Generated | | | Average Generated | | |
| Wave Frot 1.5 m | | 1P/90D | 10P/207D | 10P/360D | 1P/90D | 10P/207D | 10P/360D | 1P/90D | 10P/207D | 10P/360D |
| Hi-m | KW | KW | KW | KW | KW | KW | KW | KW | KW | KW |
| 0.50 | 1.69 | | | | | | | | | |
| 1.00 | 6.75 | | | | | | | | | |
| 1.50 | 15.19 | 3.97 | 1.53 | 0.88 | 2.98 | 1.15 | 0.66 | 3.89 | 1.50 | 0.86 |
| 2.00 | 27.00 | 12.79 | 9.98 | 5.74 | 9.59 | 7.49 | 4.31 | 12.53 | 9.78 | 5.63 |
| 2.50 | 42.19 | 21.61 | 23.12 | 13.30 | 16.21 | 17.34 | 9.97 | 21.18 | 22.66 | 13.03 |
| 3.00 | 60.75 | 30.43 | 36.26 | 20.85 | 22.82 | 27.20 | 15.64 | 29.82 | 35.53 | 20.43 |
| 3.50 | 82.69 | 39.25 | 62.23 | 35.78 | 29.44 | 46.67 | 26.84 | 38.47 | 60.98 | 35.06 |
| 4.00 | 108.00 | 48.06 | 88.19 | 50.71 | 36.05 | 66.14 | 38.03 | 47.10 | 86.43 | 49.70 |
| 4.50 | 136.69 | 56.88 | 114.87 | 66.05 | 42.66 | 86.15 | 49.53 | 55.74 | 112.57 | 64.72 |
| 5.00 | 168.75 | 65.70 | 141.54 | 81.38 | 49.28 | 106.16 | 61.04 | 64.39 | 138.71 | 79.75 |
| 5.50 | 204.19 | 74.52 | 166.18 | 95.55 | 55.89 | 124.63 | 71.66 | 73.03 | 162.85 | 93.64 |
| 6.00 | 243.00 | 83.84 | 190.81 | 109.72 | 62.88 | 143.11 | 82.29 | 82.16 | 186.99 | 107.53 |
| 6.50 | 285.19 | 92.16 | 209.75 | 120.60 | 69.12 | 157.31 | 90.45 | 90.32 | 205.55 | 118.19 |
| 7.00 | 330.75 | 100.97 | 229.80 | 132.13 | 75.73 | 172.35 | 99.10 | 98.95 | 225.20 | 129.49 |
| 7.50 | 379.69 | 109.79 | 249.87 | 143.67 | 82.34 | 187.40 | 107.76 | 107.59 | 244.87 | 140.80 |
| 8.00 | 432.00 | 118.61 | 269.94 | 155.22 | 88.96 | 202.46 | 116.41 | 116.24 | 264.54 | 152.11 |

1—The above data shown in Tables 1 and Table 2 are for a Float of 150 cm outside diameter and a height of 150 cm 2—Depending upon sea state, the float dimensions to be changed by increasing the outside diameter and reducing the height so that the total volume remains the same, i.e. 2.650 cubic meters, so that the system can extract energy from 1-meter high waves 3—The available energy in a 1-meter high wave is 6.75 KE. This gives a maximum output of 0.59 KW (6.75*81.34%*43%/4) per wave cycle of 360 degrees. It becomes a matter of cost for installing such system 4—Although s set consists of 10 units installed in line with the incoming wave, calculations show that only the first seven pumps are effective 5—Installing a prototype of reduced scale model would not provide a good approximation of the system behavior under actual sea state conditions.

### DETAILED DESCRIPTION OF THE INVENTION

### 1) General—Pumps and Generators

Dimensions of the individual WGD elements depend upon site, sea state and load requirements. Increasing the float diameter and reducing float height becomes suitable for waves as low as 50 centimeter high.

All equipment, gear drive, universal joint, pumps and generators are hermetically sealed and suitable for underwater marine installation, or for installation on a dry deck. All pipes are flanged for ease of underwater construction. Power and control cable connections are of the quick coupling type.

### 2) Novelties

There are seven novelties in the proposed WGD system.

The First novelty is simple easy offshore construction and construction costs using simple engineering principles, and combining three renewable energy sources; wave, air and ebb/tide, into one system to provide leveled and dependable electric power even if a source of renewable energy is not available, leading to competitive costs per kwh.

The second novelty is in better utilization of sea area where offshore wind turbines are installed.

the third novelty is in providing water storage on top of the offshore REWGD system that would level power output during the full wave cycle, irrespective of its duration.

The fourth novelty is a minimal system foot print of 0.0015 compared to 0.5 to 1.5 square km for 5 MW.

The fifth novelty is in the way generators produce electric power, operate in parallel and transmit power to shore. That is; generating alternating or direct current, stabilizing output voltage and operate generators in parallel.

The sixth novelty is that the system auto adjusts to varying wave heights and varying sea levels.

The seventh novelty is a Free Floating Break Water Structure, leading to calm seas behind the system and providing shore line protection without interfering with marine life or scenic view.

### 3) Operation—Pumps and Generators

As the wave front reaches its trough, the float falls down to its lowest level. When the wave instantaneous level starts to rise, it will start to immerse the float until a sufficient buoyant upward lift is developed to overcome the weight of the float and of the rack or spiral spring restraining force. Then the float starts to rise upward, until its top reaches the wave crest as maximum travel, in the mean time transmitting this uplift force to the pump operation as rotation at high revolutions per minute. by means of Rack and Pinion, Leaf Spring or a Pulley System.

A float with an outside diameter of 150 cm and a height of 150 cm develops a total uplift force of 2,650 kilograms. Dimensions of the float depend upon sea state and load requirements.

An upward travel the Float of one meter/second is converted to one rotation/second at the gear input; and 30 revolutions per second at the gear output. This is equivalent to 1,800 rpm at pump or generator.

The power generated is shown in table-1 above for different wave heights.

As the water of the wave is accelerating upward, it meets at the surface an area reduction due to the presence of the floats. This area reduction estimated at 80% leads to wave height increase of 24% and results in increased power extraction.

A set of up to ten pumps or generators are installed in line with the incoming wave to extract most of its energy. Each pump or generators is fixed to the mooring structure by means of quick coupling for ease of maintenance. A group of 100 pumps or generators fixed to the mooring structure constitutes a construction unit. Additional construction units of 100 pumps or generators are installed to provide the required power output.

### 4) Operation—Float and Gear Drive

A float in the range of 150 to 220 cm O.D. and a height of 150 to 70 cm respectively develops an uplift of 2,650 kg. The float is cylindrical, red color with red flashing lights for safety of navigation, and is provided with means for connection to the gear rack or spiral spring.

Top of gear drives and pumps are installed at a level of 6.00 meters below mean sea level or at the structure deck.

Gear drive transmits rotation to the pumps or generators in one direction. It does not transmit rotation in the opposite direction to the rack. Latching is in upward travel of the gear rack and releases on the downward travel.

Gear Drive is coupled to the pumps or generators by a hermetically sealed universal joint.

Gear drive is designed to develop per meter of float upward travel, one revolution to the gear input shaft to produce an output rotation of 30. A 4-meter high wave has an average instantaneous travel of 1-meter per second which translates to 1,800 rpm to the pumps or generators.

A set of pulleys as shown on the drawings is used to transmit the Float uplift as a rotation to the pumps or the variable speed generators. The pulley sets can be installed in horizontal or vertical position and fixed the deck ceiling or installed under the deck. A pulley system is provided to transmit the Float uplift to the Wave Water Pump and limit the piston travel to 2-meters for an 8-meter high wave.

Where an offshore fixed structure is used, all equipment including hydro turbo generator or fuelled turbo generator are installed on the deck of the structure. The structure can be used to support a hydro turbo generator to pump water to the main hydro turbine or to directly generate electric power using the ebb/tide motion of the sea water.

Where an offshore fixed structure is used, a wind turbine may be installed to generate electric power, pump water into the main hydro turbo generator input manifold, and using its support to house a Wave Air Pump o a Wave Water Pump.

Where an offshore fixed structure is used, a water reservoir above the fixed structure may be used to store pumped water for feeding into the hydro turbine as needed.

The offshore fixed structure would also act as a break water structure.

### 5) Mooring Pumps and Generators

Mooring can also be achieved by using an offshore fixed structure as shown on the drawings for each set of sixty pumps or generators.

Mooring is achieved by a submerged structure consisting of a set of hollow pipes or similar means to keep the spiral spring, gear, gear drives, generators, pumps and discharge pipes afloat with a net upward lift of 200 kg to minimize horizontal swings due to ebb/tide and sea currents.

Each mooring structure of 100 pumps or generators is tied by means of flexible lines to an anchor resting at the seabed. Flexible lines are spaced 3 meters apart to allow free movement of sharks and whales, if any.

Anchor is a set of beams of sufficient weight resting at the sea bed to hold down the mooring structure.

### 6) WGD Pumps.

11—P1 to P10 Pumps are rotary or centrifugal, connected to the reduction gear output by a universal joint. They rotate at

Shut-off and check valves control the pump operation and output.

The hydro turbo generator may be installed offshore at 5,000 meters or more as required. Hydro turbo generator is mounted above water level on a fixed supporting structure.

Supporting structure for the hydro turbo generator is fixed and anchored to the sea bed.

Power and control panel are fixed to the wall of the hydro turbo generator housing for protection and control of electrical equipment.

### 7 WGD—Generators

It is necessary to connect the outputs of the generators in parallel. Due to the difficulty of synchronizing their alternating current outputs, the AC generator outputs are converted to D.C and connected in parallel.

12—G1 are polyphase generators directly coupled to the gear drive through a universal joint, rotating at 1,800 rpm to generate alternating or direct current as needed. The AC current is converted to direct current by means of thyristor/diode circuits.

The generator field magnetic circuit consists of a series connected coil, a shunt coil to achieve a compound wound generator with a flat output voltage inspite of current output variations.

An additional and separate shunt coil is added to provide an additional magnetic field to boost the generator output voltage and allow the respective generator to be connected in parallel with adjacent generators in the 10-G set. This is achieved by:
a) Connection to the first generator D.C bus through a control circuit to boost each of the second to tenth generator A.C output voltage and allow it to be connected in parallel with the D.C output of other generator sets G2-G10.
b) By Varying the number of turns of the shunt coil, by means of a control circuit, to increase the magnetic field strength, raise the A.C output voltage, consequently the D.C voltage and allow it to be connected in parallel with the D.C output of other generator sets G2-G10.

The D.C outputs of each set of ten generators are connected in parallel, are also connected in parallel to the adjacent 10—sets to form a unit of 100 generators all connected in parallel and current transmitted to the electrical equipment at the shore, ready for distribution and/or connection to the local electric network.

### Equipment Characteristics

Spiral Spring Characteristics

### 1—Spiral Spring Extension 850 cm,

### 2—Pull Force 2,650

### 3—Retraction Force 50 kg,

### 4—One-Rotation per 1 m Spring Extension,

### 5—Directly Coupled to Reduction Gear

6—Common Housing with a Hermetically Sealed Reduction Gear.

Gear Drive Characteristics

### 1—Input Uplift, Maximum 2,650 kg, 2—Input Travel, Max 8 m

### 3—Input Rotation/Sec/1 m Travel 1

### 4—Output RPS/1-Turn Input 30

### 5—Output RPM/m Travel 1,800 Pump or Generator

### 6—Weight of Rack kg 50

### 7—Gear Drive Latches on Upward Travel & Releases on Down Travel

Pump Characteristics

1—Positive Displacement Pump Such as rotary or centrifugal
2—Rotary pumps are self-priming and deliver a constant, smooth flow, regardless of pressure variations.
3—Pump Size as required.

Hydro Turbe Generator

### 1—Offshore Installation

2—Operates using the Water Pumped to High Pressure by the Pumps

### 3—Power/Control Cables are run at Seabed to Shore.

### 8—Gear Drive Does Not Transmit Rotation From P or G Back to Spiral Spring or to Rack and Pinion Gear Drive Hermetically Sealed

“Deleted” Spiral Spring Characteristics

### 1—Spiral Spring Extension 850 cm

### 2—Pull Force 2,650 kg

### 3—Retraction Force 50 kg

### 4—Rotations per 100 cm Extension—1 Minimum

### 5—Directly Coupled to Reduction Gear

6—Common Housing with Reduction Gear

### 7—Hermetically Sealed Housing

Generator Characteristics

1—The gear Drive is a variable speed type providing constant rotation to generators, irrespective of gear drive input rotation. In this manner electric power is generated at constant voltage and frequency, which allows parallel operation of the generators.
2—The Generators generate either alternating or direct current electric power.
3—Each set of 10-Generators operate in Parallel
4—Ten sets, i.e. 100 generators constitute one construction unit.
5—Power and control cables are laid at the sea bed and connect to consumers or to a power plant at the shoreline.

Wind Turbine
1. The wind turbine has a 9-meter radius, operates in parallel with the output of the hydro turbo generator, or operates water pumps or air compressors as needed
2. The supporting structure is fixed to the REWGD structure to provide a platform for ease of construction and maintenance.

Water Reservoir:
a) Each construction unit may have a water reservoir measuring 19.00×16.75×10 meters to provide energy storage of 3,182,500 kilogram-meters
b) This energy storage would level wave power generation for a period exceeding the duration of the full wave cycle.

1. I claim: Wave Gear Drive WGD system installed in sets of one to 10-units and of multiple construction units each comprising up to 100 sets, as an aggregate apparatus and system consisting of a Float that follows wave undulations and acts on a submerged spiral spring or a Gear Rack and Pinion or a set of power pulleys, driving a Reduction Gear, appurtenances and connections to convert wave undulations to rotary motion at high revolutions per minute to drive a rotary water pump, a reciprocating water pump or a variable speed generator.

2. I claim: Mooring system for supporting and keeping the WGD system described under [claim 1] afloat with a net upward force to minimize horizontal swings, consisting of hollow pipes or other similar hollow underwater units to act as a float and anchored to the sea bed by means of flexible lines.

3. I claim: A rotary or a reciprocating water pump driven by the WGD system described under [claim 1] at high revolutions per minute, fixed to the mooring system described under [claim 2], to pump a small quantity of water to a high head, collect it and feed it to a an offshore or onshore hydro turbo generator to generate electric power, or for any other utilization, including the relevant control valves, with power and control cables laid at the sea bed and connected to electric equipment at the shore.

4. I claim: I claim: polyphase generator, driven by the WGD system described under [claim 1] at high revolutions per minute, fixed to a mooring system described under [claim 2], which drives electric generators to generate electric power, with necessary control where it is further controlled, conditioned and ready for utilization.

5. I claim: A polyphase variable speed electric generator driven by WGD system described under [claim 1] and [claim 4], to provide electric output in spite of varying RPM, to allow all generators for 1 to 100 units described under [claim 4] to be operated in parallel.

6. I claim an offshore supporting structure to house any of the wave energy extraction systems for use as a permanent installation, or to house a combination of these system's equipment and serve as a prototype for actual testing of these systems.

7. I claim an offshore supporting structure to with an elevated water reservoir to level wave energy output for a period exceeding the duration of the full wave cycle.

8. I claim an offshore supporting structure to allow for addition of ebb/tide electric generators and wind turbo generators with access platforms for ease of installation, operation and maintenance.
